(19) United States
(12) Patent Application Publication
(10) Pub. No.: US 2021/0390937 A1
(43) Pub. Date: Dec. 16, 2021

(54) System And Method Generating Synchronized Reactive Video Stream From Auditory Input

(71) Applicant: Artrendex, Inc., New Brunswick, NJ (US)

(72) Inventor: Ahmed Elgammal, East Windsor, NJ (US)

(73) Assignee: Artrendex, Inc., New Brunswick, NJ (US)

(21) Appl. No.: 17/288,606

(22) PCT Filed: Oct. 29, 2019
(86) PCT No.: PCT/US2019/058682

§ 371 Date: Apr. 26, 2021

Related U.S. Application Data
(60) Provisional application No. 62/751,809, filed on Oct. 29, 2018.

(51) Int. Cl. G10H 1/36; G10H 1/00; G06N 3/08; G06N 3/04

(52) U.S. Cl. CPC G10H 1/368; G10H 1/0008; G10H 2240/325; G06N 3/0454; G10H 2220/005; G06N 3/08

(57) ABSTRACT

A method and system for automatically generating a video stream synchronized with and reactive to an input audio stream uses one or more still or video images as a source of imagery. The system learns a latent representation of the source imagery and generates a visualization synchronized to, and reactive with, the input audio. A computer divides the audio stream into successive audio frames each characterized by a spectrogram. The computer generates a series of graphics of such latent representation according to the spectrogram of each audio frame. The computer pairs each audio frame with its corresponding graphic to generate an ordered series of graphics. The series of generated graphics can be displayed to accompany the audio in real-time or coupled with the audio stream to provide an audiovisual work that can be transmitted or digitally stored.

### PRIORITY CLAIM

The present application claims the benefit of the earlier filing date of U.S. provisional patent application No. 62/751,809, filed on Oct. 29, 2018, entitled “A System And Methods For Automatic Generation Of Video Stream Synchronized And Reactive To Auditory Input”.

### FIELD OF THE INVENTION

The present disclosure relates to systems and methods for generating video images synchronized with, and reactive to, an audio stream.

### RELATED ART

Generating visual imagery to accompany music is a difficult task which typically requires hours of work by computer graphics experts using various computer software tools. Typically, the generated visuals are not actually responsive to the music which they accompany.

Others have described computer-based techniques for creating visual displays to accompany music. For example, in U.S. Pat. No. 8,051,376 (Adhikari et al.), a customizable music visualizer is described for allowing a listener to create various effects and visualizations on a media player.

In United States Patent Application Pub. No. US 2014/0320697 A1 (Lammers et al.), a system is described wherein music can be selected for a video slideshow wherein presentation of the video is a function of the characteristics and properties of the music. For example, a beat of the accompanying music can be detected and the photos can be changed in a manner that is beat-matched to the accompanying music.

In U.S. Pat. No. 7,589,727 (Haeker), a system is described for generating still or moving visual images that reflect the musical properties of a musical composition.

In U.S. Pat. No. 7,027,124 (Foote et al.), a system is described for producing music videos automatically from source audio and video signals, wherein the music video contains edited portions of the video signal synchronized with the audio signal.

However, none of the above-summarized systems appears to create new visual images, based in part on previously sourced visual images, that were not already provided to such system, and wherein the new visual images are responsive to, and synchronized with, an incoming audio stream.

### SUMMARY

Accordingly, it is an object of the present invention to automate the generation of visual imagery to accompany an audio stream, e.g., a musical work, whereby the generated visual imagery is responsive to, and synchronized with, the audio stream which it accompanies.

It is another object of the present invention to provide a method and system that can automatically generate a synchronized reactive video stream from auditory input based upon video imagery selected in advance by a user.

It is still another object of the present invention to provide such a method and system that can generate such synchronized video stream in real time synchronized with an incoming audio stream.

It is a further object of the present invention to provide such a method and system that can generate an audio-visual work combining such synchronized video stream with a corresponding audio stream.

It is a still further object of the present invention to provide such a method and system that can generate such synchronized video stream and which need not follow any existing temporal ordering of original image sources selected by a user.

Yet another object of the present invention is to provide such a method and system wherein the source imagery may be selected from among graphic images, digital photos, artwork, and time-sequenced videos.

Briefly described, and in accordance with various embodiments, the present invention provides a method for automatically generating a video stream synchronized with, and responsive to, an audio input stream. In practicing such method according to certain embodiments, a collection of source graphic images are received. These source graphic images may be selected in advance by a user based upon a desired theme or motif. The user selection may be a collection of graphic images, or even a time-sequenced group of images forming a video. Such graphic images may include, without limitation, digital photos, artwork, and videos. A latent representation of the source graphic images is derived according to machine learning techniques.

In accordance with at least some embodiments of the present invention, the method includes the receipt of an audio stream; this audio stream may be, for example, a musical work, the sounds of ocean waves crashing onto a shore, bird calls, whale sounds, etc. This audio stream may be received in real time, as by amplifying sounds transmitted by a microphone or other sound transducer, or it may be a pre-recorded digital audio computer file. In some embodiments of the invention, the audio stream is divided into a number of sequentially-ordered audio frames, and a spectrogram is generated representing frequencies of sounds captured by each audio frame.

In various embodiments, the method includes generating a number of different samples of the latent representations of the selected graphic image(s), each of such latent representation samples corresponding to a different one of the plurality of audio frames and/or spectrograms. In practicing the method according to some embodiments, as each audio frame is processed, latent representation sample is matched to the current audio frame for display therewith. As each audio frame is played, the corresponding latent representation sample is displayed at the same time. This process can be repeated until the entire audio stream has been played.

If the audio stream is received in real time (e.g., a live musical performance), and if the generated video work is to be displayed in real time, then the method includes displaying the matched latent representation samples in real time as the audio stream is being performed.

If the audio stream is received in real time (e.g., a live musical performance), but the resulting audiovisual work is to be transmitted elsewhere, or saved for later performance, then the method includes storing the matched latent representation samples in real time as the audio stream is being processed, and storing both the audio frame and its matched latent representation sample in synchronized fashion for transmission or playback.

In other embodiments of the invention, the audio stream may be received before any latent representation samples are to be displayed. For example, the audio stream may be a pre-recorded musical work. In this case, the audio stream may be processed into audio frames, and the corresponding latent representation samples may be matched to such audio frames, in advance of the performance of such audio work, and in advance of the display of the corresponding graphic images. The resulting audiovisual work may be saved as a digital file having audio sounds synchronized with graphic images for being played/displayed at a later time.

In various embodiments of the invention, the latent representations of the selected graphic image(s) are “learned” using a generative model with an auto-encoder coupled with a Generative Adversarial Network (GAN); the GAN may include a generator for generating so-called “fake” images and a discriminator for distinguishing “fake” images from “real” images encountered during training. In this case, the “real” images may be the collection of graphic images and/or videos selected by the user as the source of aesthetic imagery.

In various embodiments, the system learns the selected aesthetics, i.e., the source graphic images or video, using machine learning. After learning latent representations of the source aesthetics; different samples of such latent representations may be reconstructed, either in real-time or offline, and mapped to corresponding audio frames. This results in a visualization that is synchronized with, and reactive to, the associated audio stream. The resulting visualization does not necessarily follow any existing temporal ordering of the original video or image source and can interpolate and/or extrapolate on the provided source images. The resulting synchronized video can then be displayed or projected to accompany the audio in real-time or coupled with the audio to generate audio-video stream that can be transmitted or stored in a digital file.

### BRIEF DESCRIPTION OF THE DRAWINGS

FIG. 1 is an abbreviated block diagram of a system and method for learning graphic images and/or video images and generating reconstructed visual images thereof.

FIG. 2 illustrates a system including a generative adversarial network (GAN) and an autoencoder for creating variation of learned imagery.

FIG. 3 is a more detailed block diagram based upon FIG. 2 and showing components of the GAN and autoencoder.

FIG. 4 is a block diagram of an embodiment of the invention wherein audio frames from either a live audio source or a pre-recorded audio source are mapped to latent representations of learned imagery to create an audiovisual work.

FIG. 5 is a block diagram of another embodiment of the invention wherein an audio stream from either a live audio source or a pre-recorded audio source is mapped to latent representations of learned imagery to create a video displayed in synchronization with the audio stream.

### DETAILED DESCRIPTION

Deep neural networks have recently played a transformative role in advancing artificial intelligence across various application domains. In particular, several generative deep networks have been proposed that have the ability to generate images that emulate a given training distribution. Generative Adversarial Networks (or “GANs”) have been successful in achieving this goal. See generally “NIPS 2016 Tutorial: Generative Adversarial Networks”, by Ian Goodfellow, OpenAI, published Apr. 3, 2017 (www.openai.com).

A GAN can be used to discover and learn regular patterns in a series of input data, or “training images”, and thereby create a model that can be used to generate new samples that emulate the training images in the original series of input data. A typical GAN has two sub networks, or sub-models, namely, a generator model used to generate new samples, and a discriminator model that tries to determine whether a particular sample is “real” (i.e., from the original series of training data) or “fake” (newly-generated). The generator tries to generate images similar to the images in the training set. The generator initially starts by generating random images, and thereafter receives a signal from the discriminator advising whether the discriminator finds them to be “real” or “fake”. The two models, discriminator and generator, can be trained together until the discriminator model is fooled about 50% of the time; in that case, the generator model is now generating samples of a type that might naturally have been included in the original series of data. At equilibrium, the discriminator should not be able to tell the difference between the images generated by the generator and the actual images in the training set. Hence, the generator succeeds in generating images that come from the same distribution as the training set. Thus, a GAN can learn to mimic any distribution of data characterized by the training data.

Another type of model used to learn images is known as an Autoencoder. A typical autoencoder is used to encode an input image to a much smaller dimensional representation that stores latent information about the input image. Autoencoders encode input data as vectors, and create a compressed representation of the raw input data, effectively compressing the raw data into a smaller number of dimensions. An associated decoder is typically used to reconstruct the original input image from the condensed latent information stored by the encoder. If training data is used to create the low-dimensional latent representations of such training data, those low dimensional latent representations can be used to generate images similar to those used as training data.

In various embodiments of the present invention, an input audio stream automatically generates a synchronized reactive video stream. The system takes offline a collection of images and/or one or more videos as the source of aesthetics. The system learns the aesthetics offline from the source video or images using machine learning, and reconstructs, in real-time or offline, a visualization that is synchronized and reactive with the input audio. The resulting visualization does not necessarily follow any existing temporal ordering of the original video or image source and can interpolate and/or extrapolate on the provided source. The resulting synchronized video can then be displayed or projected to accompany the audio in real-time or coupled with the audio to generate an audio-visual work that can be transmitted or stored in a digital file for subsequent performance.

The input audio stream can be either a live audio stream, for example, the sounds produced during a live musical performance, or a pre-recoded audio stream in analog or digital format. The input can also be an audio stream transmitted over the internet, satellite, radio waves, or other transmission methods. The input audio can contain music, vocal performances, sounds produced in nature, or man-made sounds.

The present system and method uses a collection of source graphic images as the source of aesthetics when generating the synchronized video. The source of aesthetics can be a collection of digitized images, or a collection of one or more videos (each video including a time-sequenced collection of fixed-frame graphic images). For example the source of aesthetics can be a collection of videos of thunderstorms, fire, exploding fireworks, underwater images, underground caves, flowing waterfalls, etc. The source of aesthetics does not need to be videos and can be a collection of images that do not have any temporal sequences, for example a collection of digital photos from a user travel album, or a collection of images of artworks, graphic designs, etc.

The present system and method do not simply try to synchronize the input video or images (i.e., the source of aesthetics) with an incoming audio stream. Indeed, this might not even be possible since the audio stream and the source of visual aesthetics may have nothing in common, i.e., they may have been produced independently with no initial intention of merging them into a combined work. In contrast, the system and method of the present invention learns the visual aesthetics from the source video or other graphic images, and then reconstructs a visualization that is synchronized with, and reactive to, the audio stream. Accordingly, the resulting visual display does not necessarily follow any existing temporal ordering of the original video or image source. The present system and method can generate new visual images that never existed in the original visual sources; for example, the new visual images may correspond to an interpolation or extrapolation of the pool of original source imagery.

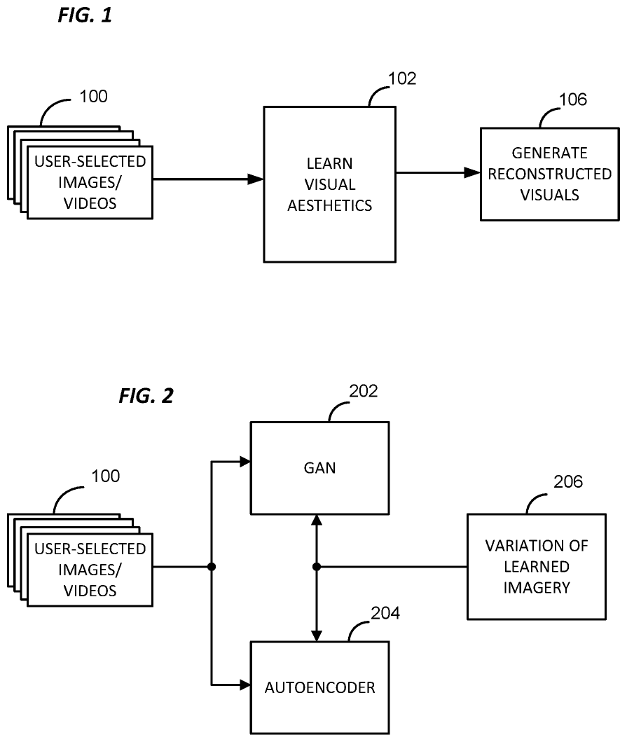

Referring to FIG. 1, block 100 represents a selection of graphic images and/or videos selected by a user as a source of visual aesthetics. As mentioned above, the source imagery may correspond to a desired theme or motif. The user-selected images may, for example, be a collection of digital photos, artwork, and/or videos. These source images are used to “train” the present system, using machine learning techniques.

Block 102 generally represents the step of “learning” basic latent representations of the visual imagery selected by the user. The user-selected images are provided as digital files, perhaps by scanning any hard-copy images in advance. Once the basic latent representations of such images are learned by the system in digital format, the system can then generate reconstructed, modified versions of such images, as represented by block 106 in FIG. 1. These basic steps can be performed even before knowing what type of audio stream will be used in practicing the invention.

FIG. 2 is a general illustration of FIG. 1 wherein the learning of the visual aesthetic images is performed by using a Generative Adversarial Network (or “GAN”) in combination with an autoencoder in order to generate variations of the learned source imagery. The goal of this process is to learn a latent low dimensional representation of the visual source of aesthetics, and to generate images from that latent representation. The operation of GANs is well known to those skilled in the art, as evidenced for example by “NIPS 2016 Tutorial: Generative Adversarial Networks”, by Ian Goodfellow, OpenAI, published Apr. 3, 2017. On the other hand, Autoencoders have also been used in the past to create highly-condensed latent representations of graphic images. While autoencoders are suited to accurately reconstruct source images, they are not generally designed to intentionally modify, or vary, the source image. By combining a GAN and an Autoencoder, the present system and method are able to create condensed latent representations of the source aesthetics while also being able to create a variety of new graphic images that are related to, though different from, the original source images.

As shown in FIG. 2, the digital files from the user-selected source images are provided to both GAN 202 and Autoencoder 204 during a training mode of operation. After such training is completed, GAN 202 can create modified forms of the source imagery, while autoencoder 204 can create condensed versions thereof. These condensed versions can be saved as latent representations in block 206. Other visual learning techniques which may be used to generate such latent representations may include a linear dimensionality reduction method or a nonlinear dimensionality reduction method combined with a nonlinear mapping function.

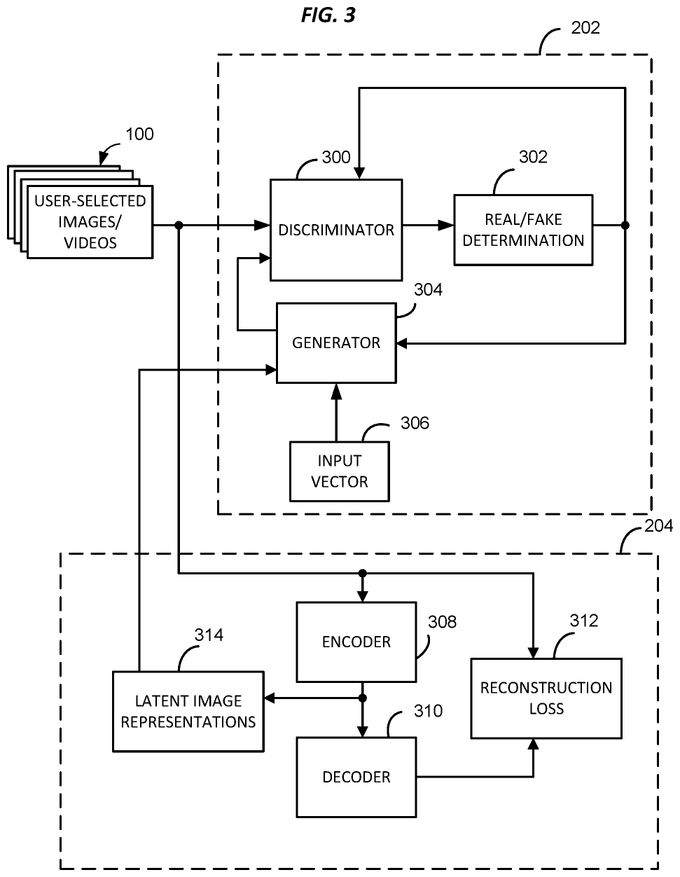

Turning to FIG. 3, GAN 202 of FIG. 2 is represented by dashed block 202 in FIG. 3, and Autoencoder 204 in FIG. 2 is represented by dashed block 204 in FIG. 3. Latent representations of the source imagery is learned through a generative model with an auto-encoder that minimizes the reconstruction error. As noted above, auto-encoders do not generalize well to generate new samples. Therefore, Auto-encoder 204 is coupled with GAN 204 which uses a Generator-Discriminator architecture. GAN 202 itself does not enable the learning of a latent representation of the graphic source data, and assumes the input comes from a given distribution, such as a Gaussian distribution. By coupling GAN 202 with Auto-encoder 204, the combination achieves both creation of latent representation samples and improves the generalization of the generated video images. A random vector that is sampled from a prior distribution trained by Autoencoder 204 may be input to generator 304 of GAN 202. Generator 304 is composed of a deep neural network using multiple layers of transposed convolution layers to generate an image from an input vector x provided by block 306. The training is achieved through a loss function that combines the autoencoder reconstruction loss with GAN loss. This learning process may be viewed as resulting in an image generator G(x) that generate images based on input x ∈ R^{d} that lives in an embedding space of dimension d. In alternate embodiments, generator 304 might contain “up-convolution” layers or fully connected layers, or a combination of different types of layers.

GAN 202 includes a discriminator 300 which includes a first input for receiving the user selected graphic images/video frames 100 during a training mode. Discriminator 300 is typically configured to compare images provided by an image generator 304 to trained images stored by discriminator 300 during training. If discriminator 300 determines that an image received from generator 304 is a real image (i.e., that it is likely to be one of the images received during training), then it signals block 302 that the image is “real”. On the other hand, if discriminator 300 determines that an image received from generator 304 is not likely to be a real image (i.e., not likely to be one of the images received during training), then it signals block 302 that the image is “fake”. Generator 304 is triggered to generate different images by input vector 306, and generator 304 also receives the “real/fake” determination signal provided by block 302. In this manner, generator 304 of GAN 202 can generate new images similar to those received during training. Computer software for implementing a GAN on a computer processor is available from The Math Works, Inc. (“MATLAB”); see https://www.mathworks.com/help/deeplearning/examples/train-generative-adversarial-network.html?searchHighlight=generative%20adversarial%20network&s_tid=doc_srchtitle.

Still referring to FIG. 3, a convolutional Auto-encoder 204 is implemented. An autoencoder is essentially a neural network using an unsupervised machine learning algorithm. Alternatively, a fully-connected auto-encoder, or a variational auto-encoder, could also be used. Autoencoder 204 includes an encoder 308 which, during training, also receives the user selected graphic images/video frames 100. Encoder 308 produces a highly condensed latent image representation of the input graphic, and provides such latent image representation to decoder 310, which reconstructs the original image from the condensed latent image representation. For additional details regarding implementation of a convolutional autoencoder, see Chablani, Manish. (Jun. 26, 2017), “Autoencoders—Introduction and Implementation in TF”; retrieved from towardsdatascience.com. Computer software which may be used to implement such an autoencoder on a computer processor is available from The MathWorks, Inc. (“MATLAB”); see.

Encoder 308 effectively condenses the original input into a latent space representation. Encoder 308 encodes the input image as a compressed representation in a reduced dimension. This compressed image is a distorted version of the original source image, and is provided to Decoder 310 for transforming the compressed image back to the original dimension. The decoded image is a lossy reconstruction of the original image that is reconstructed from the latent space representation.

The reconstructed image provided by decoder 310 is routed to reconstruction loss block 312 where it is compared to the original image received by encoder 308. Reconstruction loss block 312 determines whether or not condensed latent image representation produced by encoder 308 is sufficiently representative of the original image; if so, then the latent image representation produced by encoder 308 is stored by latent image representations block 314.

As shown in FIG. 3, latent image representations block 314 of Autoencoder 204 may be provided as an input to generator 304. GAN 202 may then be used to generate a modified form of the graphic represented by such latent representation image that is similar to one or more of the original images selected by the user but varied therefrom. As noted above, this process of creating different graphic images based upon the user-selected source graphics can be performed in advance of receiving the audio stream to which the final video work is synchronized.

The process of training (i.e., learning a latent representation) is best performed by providing many source images, and not just a single image. As an example, if the visuals to be displayed with the audio stream are to be based on images taken from caves, then it is best to source one or more videos of caves. Those video images are “ripped” to video frames (e.g., at the rate of 30 per second), and the collection of the ripped cave images are used to train a model that will generate visuals inspired by such cave videos. If, by example, the training process used 10,000 image frames to learn from, those 10,000 frames are transformed into 10,000 points within a continuous latent space (a “cloud of points”). Any point in that space (including points lying between the original 10,000 points) can be used to generate an image. The generation of such images will not follow the original time sequence of the image frames ripped from the videos. Rather, the generation of such images will be driven by the audio frames by beginning from a starting point in that latent space and moving to other points in the latent space based on the aligned audio frames.

Clearly, a user can vary the characteristics of the resulting video by changing the source images/videos. If the source images are video frames of caves, then the resulting video will differ from an alternate video resulting when the source videos are underwater scenes, images of the ocean, fireworks, etc.

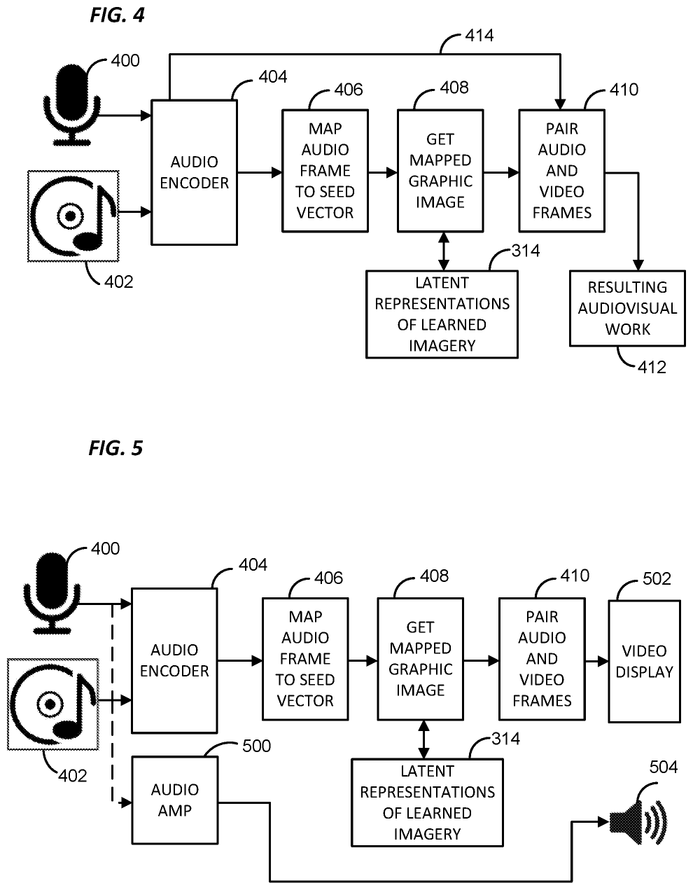

FIG. 4 shows an embodiment of the invention in a second phase wherein an audio stream is processed, and wherein video images are assembled in a manner which is reactive to, and synchronized with, the audio stream to produce an audiovisual work. As shown in FIG. 4, the incoming audio stream could be produced in real time as by providing one or more microphones 400, as when sampling a musical performance or recording sounds in nature. Alternatively, the incoming audio stream could be pre-recorded audio tracks as represented by Compact Disk 402 in FIG. 4; the pre-recorded audio stream may, for example, be stored in uncompressed format (.wav) or in a lossy compressed format (.mp3). The input audio can be either live audio stream, for example in a music concert, or a recoded audio in analog or digital format. The audio input could also be an audio stream transmitted over the internet, satellite, radio waves, or other transmission methods. The input audio can contain music and/or vocals, and might alternatively be sounds that occur in nature. In any case, the incoming audio stream is provided to an audio encoder 404. Audio encoder 404 splits the incoming audio stream into discrete audio frames. Encoding of digital audio files conventionally uses a sampling rate of 44 KHz or more. However, for purposes of the present invention, end-result video images can be generated at a much lower rate; updating the end-result video image at a rate on the order of approximately 30-50 Hz. will suffice to provide a relatively smooth end-result visual display. The conversion of the audio signal into a stream of digital snapshots samples, with each sample representing a numeric value that is proportional to the measured signal at a specific instant in time, is called sampling, and is often handled by an analog-to-digital converter in a computer sound card.

In at least one embodiment, audio encoder 404 includes a frequency analysis module to generate a spectrogram. Each audio frame analyzed by audio encoder 404 produces a spectrogram, i.e., a visual representation of the spectrum of frequencies of the audio signal as it varies with time. A person with good hearing can usually perceive sounds having a frequency in the range 20-20,000 Hz. Audio encoder 404 produces the spectrogram representation using known Fast Fourier Transform (FFT) techniques. FFT is simply a computationally-efficient method for computing the Fourier Transform on digital signals, and converts a signal into individual spectral components thereby providing frequency information about the signal. The spectrogram is quantized to a number (N) of frequency bands measured over a sampling rate of M audio frames per second. The audio frames can be represented as a function shown below:

fₜ ∈ R^{N},

where t is the time index. Computer software tools for implementing FFT on a digital computer are available from The MathWorks, Inc., Natick, Mass., USA, https://www.mathworks.com/help/matlab/math/basic-spectral-analysis.html#bve7skg-2.

There are different parameters that a user can control to vary audio-visual alignment process. For example, a user may change the effect of certain frequency bands on the generation of the resulting audio-visual work by amplifying, or de-amplifying, parts of the frequency spectrum. The user can also control the audio feed to the audio encoder, as by using an audio mixer, to amplify, or de-amplify, certain musical instruments. In addition, in the case where the audio work will be received in real time, a user can vary the selection of the prior audio work used to anticipate the audio frames that will be received when the live audio stream is received.

Still referring to FIG. 4, each audio frame processed by audio encoder 404 is mapped to a learned visual representation through an audio-visual alignment process. The encoded spectrogram produced by audio encoder 404 is provided to block 406 for mapping the audio frame to a seed vector. This mapping process pairs each audio frame fₜ to a visual seed vector xₜ through a function xₜ=V(fₜ). There are several alternatives for learning the alignment function V(fₜ). In one embodiment, the audio subspace is aligned with the visual subspace. Each such subspace is learned through Principal Component Analysis; for further details concerning application of Principle Component Analysis, see “A One-Stop Shop for Principal Component Analysis”, by Matt Brems, Apr. 17, 2017, https://towardsdatascience.com/a-one-stop-shop-for-principal-component-analysis-5582fb7e0a9c.

In applying principal component analysis to the audio-visual alignment process described above, let a1, . . . , ak be the top k modes of variation of the audio stream. Let v1, . . . , vk be the top k modes of variations of the learned video representation.

If all the audio frames are available for processing in advance, as in the case of music stored in a previously-saved digital file, the alignment process can be achieved offline as follows:
Let X={x1, . . . , xK} be a set of K samples of the learned visual distribution, where xᵢ ∈ R^{d}, and d is the dimension of the latent space dimension.
Let f₁, . . . , f_{L} be the audio frames obtained using the frequency analysis described above, where fᵢ ∈ R^{N} and N are the number of frequency bands used.
Let F be an L×N dimension matrix constructed by row stacking of the audio frames.

Modes of variation of the visual representation are obtained by computing the principal components of X, after centering the samples by subtracting their mean. Let us denote the visual mapping matrix by U ∈ R^{d×d}.

Modes of variations of the audio frame data are obtained by computing the principal components of F, after centering the audio frames by subtracting their mean. Let us denote the audio mapping matrix by W ∈ R^{N×d}, where d is the dimension of the visual representation and N is the number of frequency bands.

After projecting the audio frames to their modes of variations using the W mapping function, each dimension is scaled to match the variation in the corresponding variances in the visual space. Let F′ be the audio frames after projection and scaling, which can be written as:

F′=a(FW)⊙(I×s),

where I is a vector of ones of dimension L and s is a row vector of dimension d which element si is

$$\frac{{s}_{i}^{v}}{{s}_{i}^{a}}$$

where sᵢ^{v} is the standard deviation of the i-th dimension of the visual subspace and sᵢ^{a} is the standard deviation of the i-th dimension of the audio subspace after projection the data to their modes of variations. a is an amplification factor that control the conversion, ⊙ denotes Hadamard matrix multiplication, and × denotes the outer product.

Alternative scaling approaches could also be used, including using any function of the standard deviations of the visual and/or auditory subspace dimensions, including mean, maximum, minimum, median, percentiles or constant.

The scaled audio frames F′ are then mapped to the visual space using the transformation matrix U as follows:

F″=F′U^{T}

The rows of the matrix F″ are the audio frames mapped into the visual representation as seed vectors for generation of the corresponding visual images to be displayed with each such audio frame. This step is represented by block 406 in FIG. 4.

At block 408 of FIG. 4, a corresponding visual image is mapped to the current audio frame. This is done by passing visual seed vector xt (provided by block 406) to generator 304 (see FIG. 3) to generate the corresponding image yt=G(xt). After receiving the corresponding graphic image from generator 304, block 410 pairs the generated image with the original incoming audio stream, received via path 414, and saves the combination as in digital format as audiovisual work 412. Audiovisual work 412 can be stored for later performance and/or may be transmitted elsewhere for broadcast. The implementation of FIG. 4 thus combines the input audio source with the generated imagery into a video synchronized stream containing both audio and video tracks that can be then stored to a video file using any existing video format. Such output video can then be stored to digital device, cloud device, or streamed through the internet, or other wireless transmission networks.

In the case where the incoming audio stream is live music or streamed in real time, the process of aligning incoming audio frames to corresponding visual images can be achieved using a prior distribution of audio frames from an audio sample similar to the actual audio stream that one anticipates to receive in real time. For example, if the incoming audio stream is anticipated to be a musical performance, then a prior distribution of audio frames captured from music data of a similar genre may be used. Sample audio frames from the prior audio work are used to obtain the transformation matrix W as described above, as well as to compute the standard deviations for each dimension of the audio subspace. The transformation function V( ) is applied to each online/live audio frame fₜ to obtain the corresponding visual representation xₜ using the formula below:

xₜ=V(fₜ)=a((fₜ^{T}W)⊙(I×s))U^{T}

FIG. 5 shows an implementation similar to that of FIG. 4, and like components are identified by identical reference numbers. In the case of FIG. 5, however, the generated video images are displayed in real time on video display 502. At the same time, the incoming audio stream, which is provided to audio encoder 404, may also be provided an audio amplifier 500 and provided to speaker system 504 for being broadcast proximate video display 502.

The visual images produced for display with the audio stream can be varied in at least two ways. In a “static mode”, the displayed visual image begins at a starting point (a point in the latent space) and moves on the latent space around the starting point. Thus, if there is no audio signal for several frames (silence), the visual will revert to the starting point. In other words, the incoming audio frames cause a displacement from the starting point. In contrast, in a dynamic mode, the initial image again begins from a starting point in the latent space, and progressively moves therefrom in a cumulative manner. In this case, if the incoming audio stream temporarily becomes silent, the image displayed will differ from the image displayed at the original starting point.

It will be appreciated that a user may vary the visual images that are generated for a given piece of music simply by selecting a different starting point in the latent representation of the sourced graphic images. By selecting a new initial starting point, a new and unique sequence of visual images can be generated every time the same music is played.

Those skilled in the art should appreciate that the generated video stream may vary every time a piece of live music is played, as the acoustics of the performance hall will vary from one venue to the next, and audience reactions will vary from one performance to the next. So repetition of the same music can result in new and unique visuals.

In live musical performances, the generated synchronized video can be displayed to accompany the performance using any digital light emitting display technology including LCD, LED screens and other similar devices. The output video can also be displayed using light projectors. The output video can also be displayed through virtual reality or augmented reality devices. The output video can also be streamed through wired or wireless networks to display devices in remote venues.

The system is composed of audio input devices through microphones and sound engineering panels which feeds into a special purpose computer equipped with graphical processing unit (GPU). The output is rendered using a projector, or a digital screen, or directly stored into a digital file system.

User interaction with the system is through a graphical user interface which can be web-based or running on the user machine. Through the interface the user is provided with controls over the process in terms of choosing the input stream, choosing the source of aesthetics, controlling the parameters that affects the process, and directing the output stream.

The computerized components discussed herein may include hardware, firmware and/or software stored on a computer readable medium. These components may be implemented in an electronic device to produce a special purpose computing system. The computing functions may be achieved by computer processors that are commonly available, and each of the basic components (e.g., GAN 202, Autoencoder 204, and audio-encoding/mapping blocks 404-410) can be implemented on such computer processor using available computer software known to those skilled in the art as evidenced by the supporting technical articles cited herein.

The embodiments discussed herein are illustrative of the present invention. As these embodiments of the present invention are described with reference to illustrations, various modifications or adaptations of the methods and or specific structures described may become apparent to those skilled in the art. For example, while the embodiments described herein use GAN 202 in combination with Autoencoder 204 to learn the latent representations of the source graphic images, the generation of such latent representations can also be achieved using GAN-only models, such as a conditional GAN, an info-GAN, a Style-GAN, and other GAN variants that are capable of learning a latent representation from data or generating images based on an a continuous or discrete input latent space. Alternatively, an auto-encoder-only model could also be implemented using types of auto-encoders that generalize more effectively than the above-described convolutional auto-encoder, such as a Variational Auto-Encoder. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. Several embodiments are specifically illustrated and/or described herein. However, it will be appreciated that modifications and variations are covered by the above teachings and within the scope of the appended claims without departing from the spirit and intended scope thereof.

What is claimed is:

1. A method for automatic generation of a synchronized reactive video stream from auditory input comprising the steps of:
a) receiving a plurality of source graphic images;
b) learning a latent representation of the plurality of source graphic images;
c) receiving an audio stream;
d) dividing the audio stream into a plurality of sequentially-ordered audio frames;
e) generating a spectrogram representing frequencies of each audio frame;
f) generating a plurality of different samples of the latent representation of the plurality of source graphic images, each of such plurality of different latent representation samples corresponding to a different one of the plurality of audio frames;
g) selecting a first audio frame for being played, and selecting a corresponding latent representation sample for display while the first audio frame is being played;
h) displaying the selected latent representation sample while playing the first audio frame;
i) selecting a next audio frame for being played, and selecting a corresponding next latent representation sample for display while the next audio frame is being played;
j) displaying the selected next latent representation sample while playing the next audio frame; and
repeating steps i) and j) for each of the audio frames in the audio stream.

2. The method recited by claim 1 wherein the plurality of source graphic images is selected from the group of graphic images that includes digital photos, artwork, and videos.

3. The method recited by claim 1 wherein the audio stream is received before any latent representation samples are displayed.

4. The method recited by claim 1 wherein the audio stream is received substantially in real time while latent representation samples are displayed.

5. The method recited by claim 1 wherein the step of learning the latent representation of the plurality of source graphic images includes using a generative model with an auto-encoder coupled with a Generative Adversarial Network (GAN).

6. A method for automatic generation of a synchronized reactive video stream from auditory input comprising the steps of:
a) receiving a plurality of source graphic images;
b) learning a latent representation of the source graphic images;
c) receiving an audio stream;
d) dividing the audio stream into a plurality of sequentially-ordered audio frames;
e) generating a spectrogram representing frequencies of each audio frame;
f) generating a plurality of different samples of the latent representation of the source graphic images, each of such plurality of different latent representation samples corresponding to a different one of the plurality of audio frames;
g) selecting a first audio frame, and selecting a corresponding latent representation sample for being displayed when the first audio frame is being played;
h) selecting a next audio frame, and selecting a corresponding next latent representation sample for being displayed when the next audio frame is being played; repeating steps g) and h) for each of the audio frames in the audio stream; and
i) storing each such audio frame and each corresponding latent representation sample in a time-ordered sequence for providing a synchronized video stream reactive to the audio stream.

7. The method recited by claim 6 wherein the plurality of source graphic images is selected from the group of graphic images that includes digital photos, artwork, and videos.

8. The method recited by claim 6 wherein the audio stream is received before any latent representation samples are selected.

9. The method recited by claim 6 wherein the audio stream is received substantially in real time as audio frames and corresponding latent representation samples are stored in time-ordered sequence.

10. The method recited by claim 6 wherein the step of learning the latent representation of the plurality of source graphic images includes using a generative model with an auto-encoder coupled with a Generative Adversarial Network (GAN).

11. A computing system for automatic generation of a synchronized reactive video stream from auditory input comprising in combination:
a) a graphic image receiver for receiving a plurality of source graphic images;
b) a computer configured to learn a latent representation of the plurality of source graphic images;
c) an audio stream receiver;
d) the computer being configured to divide the audio stream into a plurality of sequentially-ordered audio frames;
e) the computer being configured to generate a spectrogram representing frequencies of each audio frame;
f) the computer being configured to generate a plurality of different samples of the latent representation of the plurality of source graphic images, each of such plurality of different latent representation samples corresponding to a different one of the plurality of audio frames;
g) the computer being configured to select a first audio frame for being played, and configured to select a corresponding latent representation sample for display while the first audio frame is being played;
h) a display coupled to the computer for displaying the selected latent representation sample while playing the first audio frame;
i) the computer being configured to select a next audio frame for being played, and to select a corresponding next latent representation sample for display while the next audio frame is being played;
j) the display displaying the selected next latent representation sample while playing the next audio frame;
whereby the computer is configured to continue select sequentially-ordered audio frames and corresponding latent representation samples for each of the audio frames in the audio stream.

12. The computing system recited by claim 11 wherein the graphic image receiver is adapted to receive a plurality of source graphic images selected from the group of graphic images that includes digital photos, artwork, and videos.

13. The computing system recited by claim 11 wherein the audio stream receiver is adapted to receive the audio stream before any latent representation samples are displayed.

14. The computing system recited by claim 11 wherein the audio stream receiver is adapted to receive the audio stream substantially in real time while latent representation samples are displayed.

15. The computing system recited by claim 11 wherein the computing system includes an auto-encoder coupled with a Generative Adversarial Network (GAN) for learning the latent representation of the plurality of source graphic images.

16. A computing system for automatic generation of a synchronized reactive video stream from auditory input comprising in combination:
a) a graphic image receiver for receiving a plurality of source graphic images;
b) a computer configured to learn a latent representation of the plurality of source graphic images;
c) an audio stream receiver receiving an audio stream;
d) the computer being configured to divide the audio stream into a plurality of sequentially-ordered audio frames;
e) the computer being configured to generate a spectrogram representing frequencies of each audio frame;
f) the computer being configured to generate a plurality of different samples of the latent representation of the plurality of source graphic images, each of such plurality of different latent representation samples corresponding to a different one of the plurality of audio frames;
g) the computer being configured to select a first audio frame, and configured to select a corresponding latent representation sample for being displayed when the first audio frame is being played;
h) the computer being configured to select a next audio frame, and to select a corresponding next latent representation sample for display when the next audio frame is being played; and
i) the computer including storage for storing each such audio frame and each corresponding latent representation sample in a time-ordered sequence for providing a synchronized video stream reactive to the audio stream.

17. The computing system recited by claim 16 wherein the graphic image receiver is adapted to receive a plurality of source graphic images selected from the group of graphic images that includes digital photos, artwork, and videos.

18. The computing system recited by claim 16 wherein the audio stream receiver is adapted to receive the audio stream before any latent representation samples are displayed.

19. The computing system recited by claim 16 wherein the audio stream receiver is adapted to receive the audio stream substantially in real time while latent representation samples are displayed.

20. The computing system recited by claim 16 wherein the computing system includes an auto-encoder coupled with a Generative Adversarial Network (GAN) for learning the latent representation of the plurality of source graphic images.
